(19) United States
(12) Patent Application Publication
(10) Pub. No.: US 2013/0227345 A1
(43) Pub. Date: Aug. 29, 2013

(54) Logically Extended Virtual Disk

(71) Applicants: Vinay G. Gadekar, Pune (IN); Janmejay S. Kulkarni, Navi Mumkbai (IN); Sarvesh S. Patel, Nasik (IN); Ashish R. Pathak, Pune (IN)

(72) Inventors: Vinay G. Gadekar, Pune (IN); Janmejay S. Kulkarni, Navi Mumkbai (IN); Sarvesh S. Patel, Nasik (IN); Ashish R. Pathak, Pune (IN)

(73) Assignee: International Business Machines Corporation, Armonk, NY (US)

(21) Appl. No.: 13/407,135

(22) Filed: Feb. 28, 2012

(51) Int. Cl. G06F 11/20

(52) U.S. Cl. 714/6.22; 714/E11.09

(57) ABSTRACT

A mechanism is provided for provisioning and allocating logically extended virtual disks. Responsive to an identification of a negative operational issue with a storage device in a plurality of storage devices in a storage subsystem, a determination is made as to whether a hot spare disk is available to replace the storage device. Responsive to the hot spare disk being unavailable, a logically extended virtual disk is allocated as a replacement for the storage device. Data stored on the storage device is then rebuilt on the logically extended virtual disk.

### BACKGROUND

The present application relates generally to an improved data processing apparatus and method and more specifically to mechanisms for logically extended virtual disks.

In storage subsystems, storage devices are grouped together forming a redundant array of independent disks (RAID) group. Based on requirements, a specified RAID type may be implemented across the group of storage devices. Further, each RAID group may be partitioned into smaller individual logical units as customer logical unit numbers (LUNs). These LUNs may not always consume all of the space in their parent RAID group and, thus, available or spare storage space may be scattered throughout the parent RAID group. This spare space may vary in availability and may remain unused, as that spare space alone may not be sufficient to be used as customer LUNs.

### SUMMARY

In one illustrative embodiment, a method, in a data processing system, is provided for provisioning and allocating logically extended virtual disks. The illustrative embodiment determines whether a hot spare disk is available to replace a storage device in response to an identification of a negative operational issue with the storage device in a plurality of storage devices in a storage subsystem. The illustrative embodiment allocates a logically extended virtual disk as a replacement for the storage device in response to the hot spare disk being unavailable. The illustrative embodiment then rebuilds data stored on the storage device on the logically extended virtual disk.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1A depicts a data processing network in which aspects of the illustrative embodiments may be implemented;

FIG. 1B depicts a detailed illustration of a Fibre Channel fabric in which aspects of the illustrative embodiments may be implemented;

FIG. 2 is an example block diagram of a computing device in which aspects of the illustrative embodiments may be implemented;

FIG. 3 depicts a logically extended virtual disk system that utilizes spare space left unallocated across a same RAID group or different but compatible RAID groups in a storage subsystem in an event of a failed or failing storage device or an identification of an unsafe storage device in accordance with an illustrative embodiment;

FIG. 4 depicts a flowchart of allocating and monitoring a storage subsystem in accordance with an illustrative embodiment; and

FIG. 5 depicts a flowchart of operation performed in provisioning and allocating logically extended virtual disks responsive to an event in accordance with an illustrative embodiment.

### DETAILED DESCRIPTION

The illustrative embodiments provide for logically extending virtual disks. That is, as discussed previously, logical unit numbers (LUNs) within a particular redundant array of independent disks (RAID) group may not always consume all of the space in their parent RAID group and, thus, available or spare storage space may be scattered throughout the parent RAID group. The illustrative embodiments utilize spare space left unallocated across different but compatible RAID groups in a storage subsystem that is not used for customer LUNs. A size of these unused areas or unallocated spaces may vary from RAID group to RAID group on the storage subsystem. As such, these unused areas or unallocated spaces from compatible RAID groups may be pooled together to form a single virtual LUN of a size as per requirement, which may be utilized for providing protection to the storage subsystem itself as well as for providing additional capacity for customer LUNs. That is, the illustrative embodiments utilize the unused areas or unallocated space and do not enforce any space reservations, for the free space to be maintained.

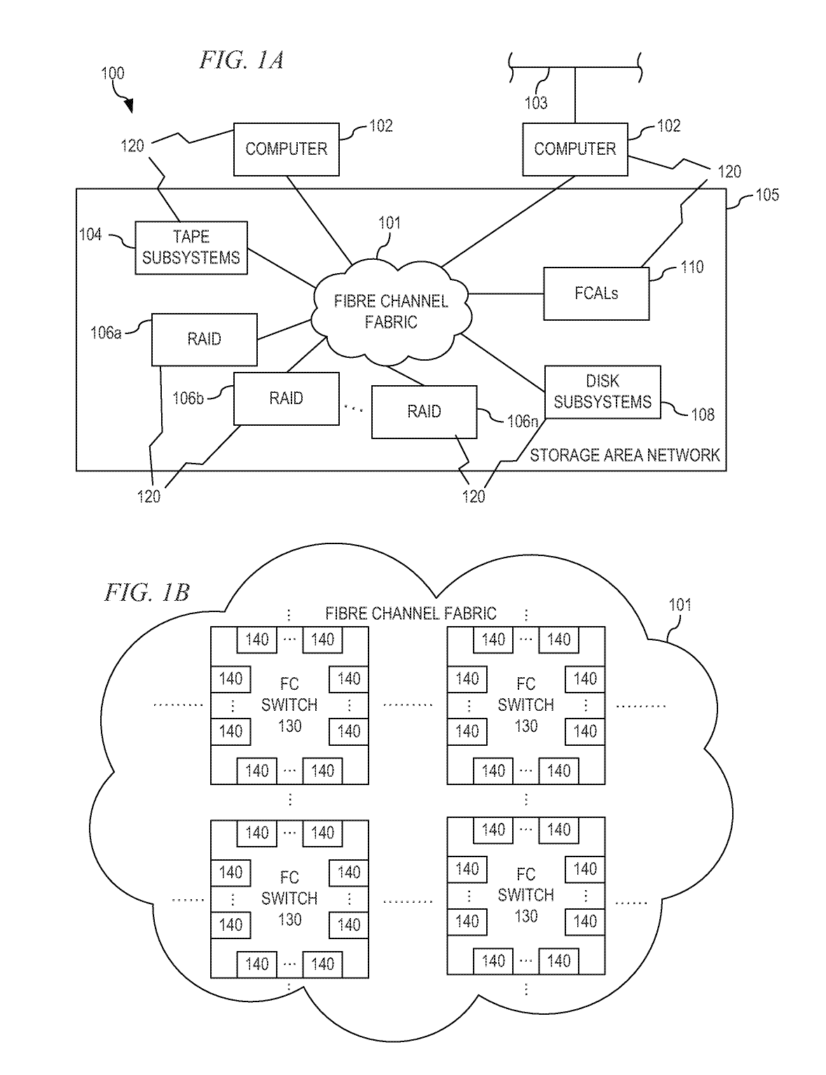

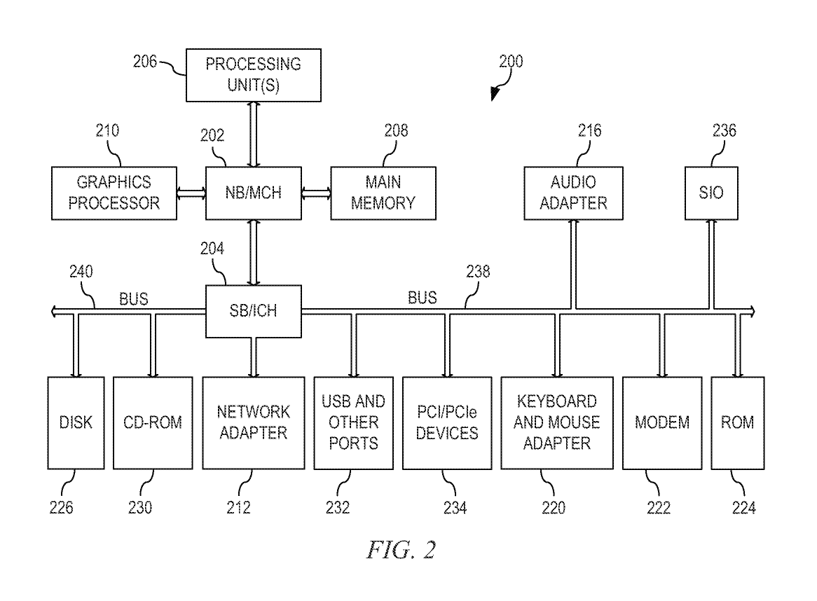

Thus, the illustrative embodiments may be utilized in many different types of data processing environments. In order to provide a context for the description of the specific elements and functionality of the illustrative embodiments, FIGS. 1A, 1B, and 2 are provided hereafter as example environments in which aspects of the illustrative embodiments may be implemented. It should be appreciated that FIGS. 1A, 1B, and 2 are only examples and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1A depicts a data processing network 100 in which aspects of the illustrative embodiments may be implemented. Network 100 comprises a storage area network (SAN) 105 that, in the depicted example, is a Fibre Channel compliant SAN. Fibre Channel is a scalable technology data transfer interface technology that maps several common transport protocols, including Internet Protocol (IP) and Small Computer System Interface (SCSI), allowing it to merge high-speed I/O and networking functionality in a single connectivity technology. Fibre Channel is a set of open standards defined by American National Standards Institute (ANSI) and International Organization for Standardization (ISO). Detailed information regarding the various Fibre Channel standards is available from ANSI Accredited Standards Committee (ASC) X3T11, which is primarily responsible for the Fibre Channel project. These standards are collectively referred to in this specification as the Fibre Channel standard or the Fibre Channel specification. Fibre Channel operates over both copper and fiber optic cabling at distances of up to 10 Kilometers and supports multiple inter-operable topologies including point-to-point, arbitrated-loop, and switching (and combinations thereof).

It should be appreciated that while the illustrative embodiments will be described in terms of using Fibre Channel and a Fibre Channel fabric, the illustrative embodiments are not limited to such. Rather, any interface technology, communication suite, or communication protocol may be utilized with the mechanisms of the illustrative embodiments without departing from the spirit and scope of the present invention. Fibre Channel is only used as an example and is not intended to state or imply any limitation with regard to the types of communication connections or protocols that may be used with the mechanisms of the illustrative embodiments.

The depicted embodiment of SAN 105 comprises a set of nodes 120 that are interconnected through a Fibre Channel fabric 101. The nodes 120 of network 100 may include any of a variety of devices or systems including, as shown in FIG. 1A, one or more data processing systems (computers) 102, tape subsystems 104, RAID devices 106a-106n, disk subsystems 108, Fibre Channel arbitrated loops (FCALs) 110, and other suitable data storage and data processing devices. One or more nodes 120 of network 100 may be connected to an external network 103. The external network 103 may be a local area network (LAN), a wide area network (WAN), or the like. For example, external network 103 may be an Internet Protocol (IP) supported network, such as the Internet.

FIG. 1B depicts a detailed illustration of a Fibre Channel fabric, such as Fibre Channel fabric 101 of FIG. 1A, in which aspects of the illustrative embodiments may be implemented. Typically, Fibre Channel fabric 101 includes one or more interconnected Fibre Channel switches 130, each of which includes a set of Fibre Channel ports 140. Each port 140 typically includes a connector, a transmitter, a receiver, and supporting logic for one end of a Fibre Channel link and may further include a controller. Ports 140 act as repeaters for all other ports 140 in Fibre Channel fabric 101. Fibre channel ports are described according to their topology type. An F port denotes a switch port (such as are shown in FIG. 1B), an L or NL port denotes an Arbitrated-Loop link (not shown in FIG. 1B), and an FL port denotes an Arbitrated-Loop to Switch connection port (also not shown in FIG. 1B). The ports 140 communicate in a standardized manner that is independent of their topology type, allowing Fibre Channel to support inter-topology communication.

As stated above, FIGS. 1A and 1B are intended as an example, not as an architectural limitation for different embodiments of the present invention, and therefore, the particular elements shown in FIGS. 1A and 1B should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as computer 102 in FIG. 1A, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1A, 1B, and 2 may vary depending on the implementation. Other internal hardware or peripheral devices, such as flash memory, equivalent non-volatile memory, or optical disk drives and the like, may be used in addition to or in place of the hardware depicted in FIGS. 1A, 1B, and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

In the illustrative embodiments, in a storage subsystem, such as storage array network 105 of FIG. 1, which is configured with redundant array of independent disks (RAID) groups and logical unit numbers (LUNs), if one or more of the storage devices, such as a hard disk drive (HDD) or solid state device (SSD) in a particular LUN within a particular RAID group fails or is otherwise experiencing issues that inhibit a correct operation of the of the LUN, thereby resulting in a faulted RAID group. The illustrative embodiments utilize spare space left unallocated across a same RAID group or different but compatible RAID groups in a storage subsystem that is not used for customer LUNs.

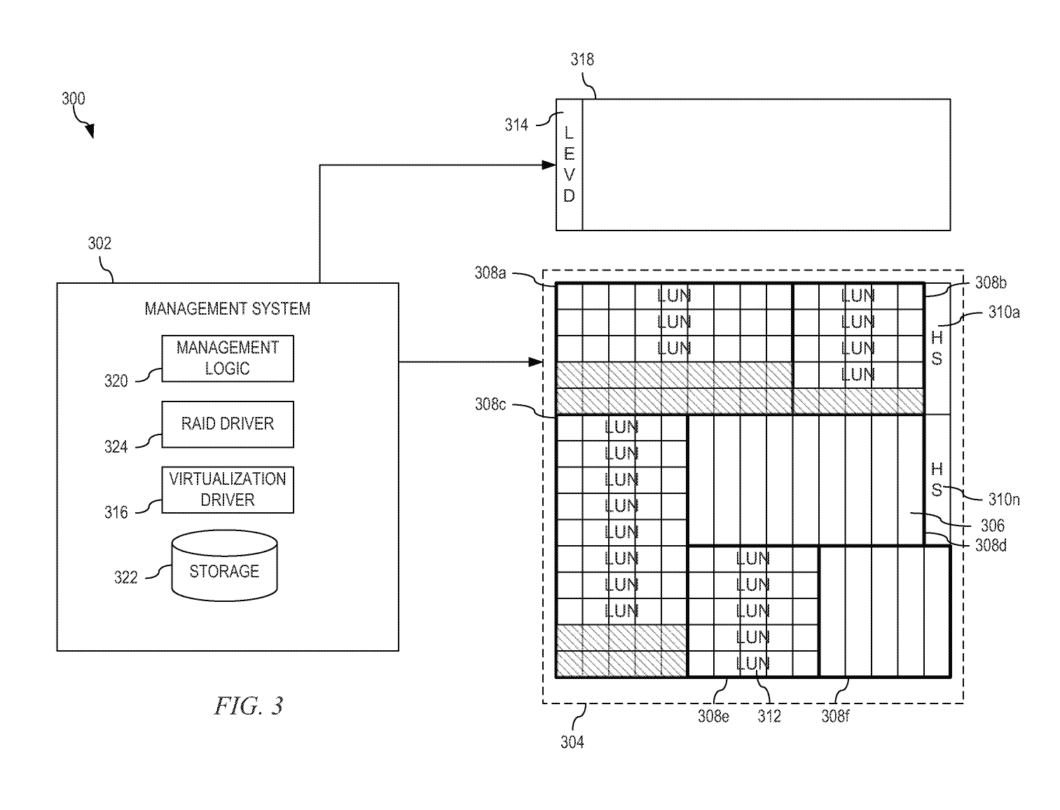

FIG. 3 depicts a logically extended virtual disk system that utilizes spare space left unallocated across a same RAID group or different but compatible RAID groups in a storage subsystem in an event of a failed or failing storage device or an identification of an unsafe storage device in accordance with an illustrative embodiment. Data processing system 300 comprises management system 302 and storage subsystem 304. As is illustrated, storage subsystem 304 comprises a plurality of storage devices 306, that are divided into different RAID groups 308a-308f as well as hot spare disks 310a-310n. Storage device 306 may be any combination of one or more computer readable medium(s) that may be utilized, such as a hard disk drive, solid state device, or any other type of storage device currently known or generated in the future that may be used in any combination within a redundant array of independent disks (RAID).

Although hot spare disks 310a-3100n are represented as individual hot spares, the illustrative embodiments are not limited as such. That is, a hot spare disk may be a disk or group of disks which is used to automatically or manually, depending upon the hot spare policy, replace a failing, failed, or unsafe storage device in a RAID configuration. A hot spare disk reduces the mean time to recovery (MTTR) for a RAID redundancy group, thus reducing the probability of a second disk failure and resultant data loss that may occur in any singly redundant RAID (e.g., RAID-1, RAID-5, RAID-10, or the like). Typically, a hot spare disk is available to replace a number of different disks and/or systems. Employing a hot spare disk normally requires a redundant group to allow time for the data to be generated onto the hot spare disk. During this time, a system is exposed to data loss due to a subsequent failure, and therefore the automatic switching to a spare disk reduces the time of exposure to that disk compared to manual discovery and implementation. The concept of hot spare disks is not limited to hardware, but also software systems may be held in a state of readiness, for example, a database server may have a software copy on hot standby, possibly even on the same machine to cope with the various factors that make a database unreliable, such as the impact of disc failure, poorly written queries or database software errors.

As is also illustrated, each of RAID groups 308a-308f have all or a portion of each RAID group portioned into one or LUNs 312, which may be allocated across a RAID group (as illustrated) or to a specific one or more storage devices within the RAID group. Thus, when storage subsystem 304 is populated with storage devices 306, management logic 320 in management system 302 may partition the storage devices 306 into a plurality of RAID groups 308a-308f, while leaving some storage devices as hot spare disks 310a-310n. Further, when customers are provided access to storage subsystem 304, management logic 320 creates one or more LUNs 312 for the customer within a particular one or more of RAID groups 308a-308f. As storage subsystem 304 is populated with storage devices 306 and provisioned by management logic 320 into one or more of RAID groups 308a-308f and as RAID groups 308a-308f are provisioned with LUNs 312, management logic 320 records both allocated and unallocated storage across storage subsystem 304 as well as both allocated an unallocated storage within each of RAID groups 308a-308f in storage 322. Based on the allocated and unallocated storage, management logic 320 is able to determine a maximum number of storage devices 306 within storage subsystem 304 that may be protected utilizing known protection mechanisms and the logically extended virtual disk system of the illustrative embodiments, which is described hereinafter.

That is, once storage subsystem 304 is provisioned with storage devices 306 and LUNs 312 and storage subsystem 304 is being utilized by one or more customers, management logic 320 performs monitoring of each and every one of storage devices 306 in storage subsystem 304 in order to identify one or more of storage devices 306 that may be experiencing errors, such as too many media errors, cyclic redundancy check (CRC) failures, hardware failures, etc. In accordance with known protection mechanisms, if a storage device 306 in storage subsystem 304 fails or is on the verge of failing or is identified as unsafe, management logic 320 allocates one of hot spare disks 310a-310n as a replacement for storage device 306. Upon allocation, a RAID driver 324 rebuilds the data stored on the failed, failing, or unsafe storage device on, for example, hot spare disk 310a, so that hot spare disk 310a acts as a replacement for the failed, failing, or unsafe storage device 306. Upon allocation of one or more hot spare disks 310a-310n such that sufficient backup storage capacity to meet, for example, service level agreements (SLAs), service level objectives (SLOs), or the like, is no longer being met, management logic 320 initiates the creation of one or more logically extended virtual disks 314.

That is, as indicated above, management logic 320 records both allocated and unallocated storage across storage subsystem 304 as well as both allocated and unallocated storage within each of RAID groups 308a-308f. Using this information, management logic 320 determines a maximum number of storage devices 306 that may be protected using hot spare disks 310a-310n as well as the inventive logically extended virtual disks 314. While hot spare disks 310a-310n are each a one-for-one storage device protection mechanism, the unallocated or unutilized storage space within RAID groups 308a-308f for logically extended virtual disks 314 varies based on the LUNs allocated within RAID groups 308a-308f. From the unutilized storage space within RAID groups 308a-308f, management logic 320 may determine a number of storage devices 306 within storage subsystem 304 that may be protected utilizing hot spare disks 310a-310n and logically extended virtual disks 314. Further management logic 320 may determine a number of hot spare disks 310a-310n that must be allocated to provide protection for a failing storage device 306 within storage subsystem 304 before management logic 320 provisions logically extended virtual disks 314.

Upon allocation of one or more of hot spare disks 310a-310n such that sufficient backup storage capacity is no longer being met, management logic 320 allocates any unutilized storage space within each of RAID groups 308a-308f as an independent LUN within that particular RAID group. An independent LUN is a LUN that is not assigned to a particular customer. Management logic 320 then groups the allocated independent LUNs, if any, within RAID groups 308a-308f into a single compounded LUN. Virtualization driver 316 within management system 302 then converts, maps, and masks the single compounded LUN into one or more logically extended virtual disks 314 each equal in size to a storage device in storage subsystem 304. Virtualization driver 316 then provides a representation for the single compounded LUN in logical container 318 in storage subsystem 304. That is, each logically extended virtual disk 314 generated by virtualization driver 316 is equivalent in size to the storage capacity of a single storage device in storage subsystem 304. Thus, based on the unutilized storage space in RAID groups 308a-308f, virtualization driver 316 may be able to generate any number of logically extended virtual disks 314 up to an amount less than or equivalent to the unutilized storage space within RAID groups 308a-308f. However, virtualization driver 316 only generates enough logically extended virtual disks 314 to meet the protection requirements for storage subsystem 304.

Once virtualization driver 316 has generated logically extended virtual disks 314, management logic 320 continues to monitor each and every storage device in storage subsystem 304 in order to identify storage devices that may be experiencing errors. In an event that more storage devices have failed, are failing, or are identified as unsafe, than there are available hot spare disks 310a-310n, as opposed to currently known systems, management logic 320 allocates one of logically extended virtual disk 314 as a replacement storage device. Upon allocation, a RAID driver 324 rebuilds the data stored on the failed, failing, or unsafe storage device on logically extended virtual disk 314 so logically extended virtual disk 314 acts as a replacement or shadow for the failed, failing, or unsafe storage device.

Thus, the illustrative embodiments provide for utilizing unallocated storage space within RAID groups 308a-308f for protection in the event of a failed, failing or unsafe storage device being identified in storage subsystem and no hot spare disks being available. Once the failed, failing, or unsafe storage devices have been repaired or replaced and data has been rebuilt on the repaired or replaced storage devices from the hot spare disks or logically extended virtual disk, such that there is sufficient protection available, virtualization driver 316 destroys any unneeded ones of logically extended virtual disks 314 that are not required to provide protection so that the unutilized storage space in the RAID groups 308a-308f may be allocated for customer usage.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

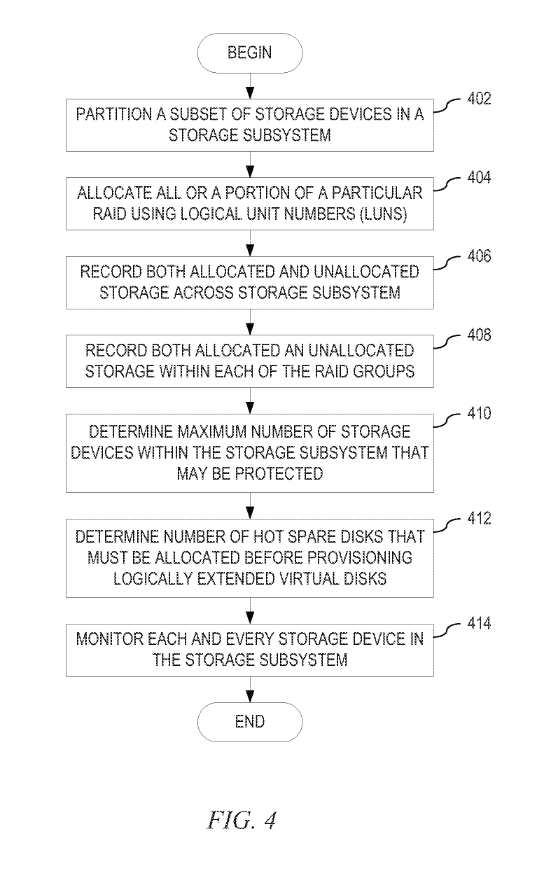

FIG. 4 depicts a flowchart of allocating and monitoring a storage subsystem in accordance with an illustrative embodiment. As the operation begins, management logic partitions a subset of storage devices in a storage subsystem into a plurality of redundant array of independent disks (RAID) groups as well as identifying the remaining subset of the storage devices as hot spare disks (step 402). As customer requests for storage are received, the management logic allocates all or a portion of a particular RAID using logical unit numbers (LUNs) (step 404). The management logic records both allocated and unallocated storage across storage subsystem (step 406). The management logic further records both allocated an unallocated storage within each of the RAID groups (step 408).

Based on the allocated and unallocated storage, the management logic determines a maximum number of storage devices within the storage subsystem that may be protected utilizing known protection mechanisms as well as a logically extended virtual disk system (step 410). That is, using this information, the management logic determines a maximum number of storage devices that may be protected using hot spare disks as well as the inventive logically extended virtual disks. Further, the management logic may determine a number of hot spare disks that must be allocated to provide protection for failing storage devices within the storage subsystem before the management logic provisions logically extended virtual disks (step 412). The management logic performs monitoring of each and every storage device in the storage subsystem in order to identify storage devices that have failed, are failing, or have been identified as unsafe (step 414), with this operation ending thereafter.

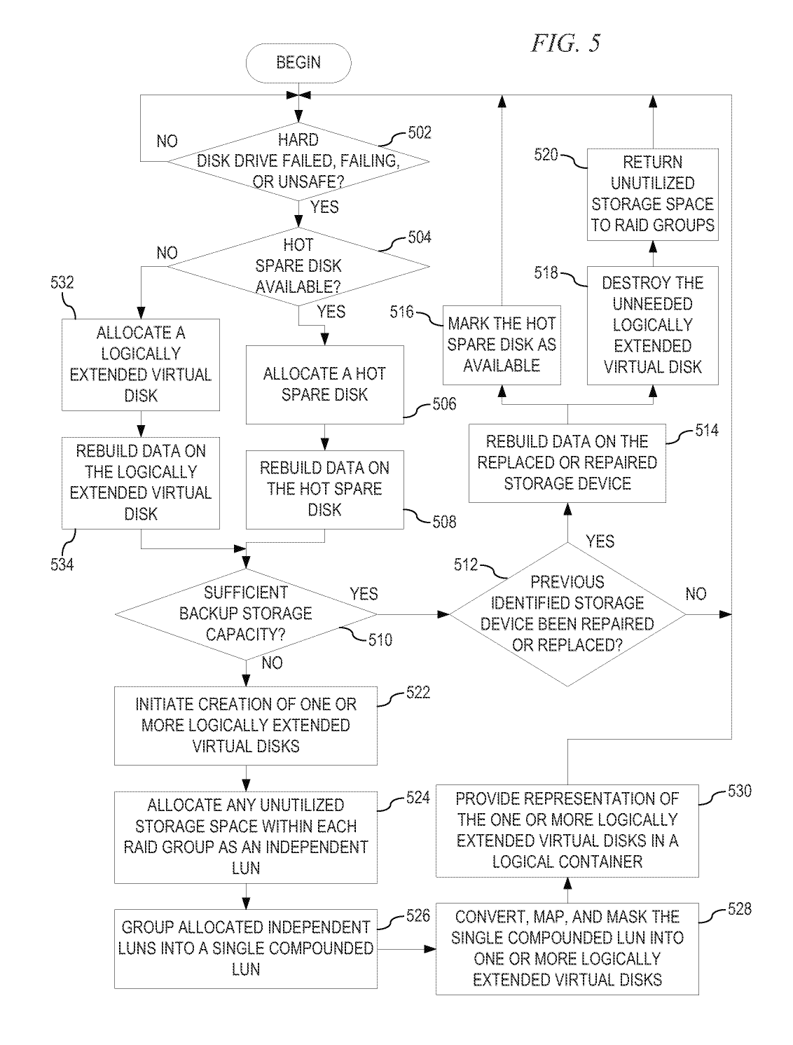

FIG. 5 depicts a flowchart of operation performed in provisioning and allocating logically extended virtual disks responsive to an event in accordance with an illustrative embodiment. As the operation begins, the management logic monitors each and every storage device in the storage subsystem in order to identify storage devices that have failed, are failing, or have been identified as unsafe (step 502). If at step 502, no failed, failing, or unsafe storage device has been identified, the operation returns to step 502 for continued monitoring. If at step 502 a storage device in storage subsystem fails, or is identified as being on a verge of failing, or is identified as unsafe, the management logic determines whether there is a hot spare disk available (step 504). If at step 504 there is a hot spare disk available, the management logic allocates a hot spare disk as a replacement storage device (step 506). Upon allocation, a RAID driver rebuilds the data stored on the failed, failing, or unsafe storage device on the hot spare disk, so that the hot spare disk acts as a replacement or shadow for the failed, failing, or unsafe storage device (step 508). Upon allocation of the hot spare disk, the management logic determines whether there is still sufficient backup storage capacity to meet current requirements (step 510).

If at step 510 there is sufficient backup storage capacity, then the management logic determines whether any hot spare disk or previously generated logically extended virtual disk is no longer needed because of its associated failed failing, or unsafe storage device for which the hot spare disk or logically extended virtual disk was allocated has been repaired or replaced (step 512). If at step 512 a hot spare disk or previously generated logically extended virtual disk is still needed, then the operations proceeds to step 502. If at step 512 a hot spare disk or previously generated logically extended virtual disk is no longer needed, then the RAID driver rebuilds the data stored on the hot spare disk or logically extended virtual disk back to the replaced or repaired storage device (step 514). If the backup disk was a hot spare disk, then the management logic marks the hot spare disk as available (step 516), with the operation returning to step 502 thereafter. If the backup disk was a logically extended virtual disk, then the virtualization driver destroys the unneeded logically extended virtual disk (step 518) and returns the unutilized storage space to the RAID groups (step 520), with the operation returning to step 502 thereafter.

If at step 510 there is not sufficient backup storage capacity, the management logic initiates the creation of one or more logically extended virtual disks to suffice the protection requirements for the storage subsystem (step 522). The management logic allocates any unutilized storage space within each of the RAID groups as an independent LUN within that particular RAID group (step 524). The management logic groups the allocated independent LUNs, if any, within the RAID groups into a single compounded LUN (step 526). A virtualization driver within the management logic then converts, maps, and masks the single compounded LUN into one or more logically extended virtual disks each equal in size to a storage device in the storage subsystem (step 528). The virtualization driver then provides a representation of the one or more logically extended virtual disks in a logical container in the storage subsystem (step 530), with the operation returning to step 502 thereafter.

If at step 504 there fails to be a hot spare disk available, the management logic allocates a logically extended virtual disk in the logical container as a replacement storage device (step 532). Upon allocation, a RAID driver rebuilds the data stored on the failed, failing, or unsafe storage device on the logically extended virtual disk, so that the logically extended virtual disk acts as a replacement or shadow for the failed, failing, or unsafe storage device (step 534), with the operation proceeding to step 510 thereafter.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for utilizing unallocated storage space within RAID groups for protection in the event of a failed, failing or unsafe storage device being identified in storage subsystem and no hot spare disks being available. Once the failed, failing, or unsafe storage devices have been repaired or replaced and data has been rebuilt on the repaired or replaced storage devices from the hot spare disks or logically extended virtual disk, such that there is sufficient protection available, virtualization driver destroys any unneeded logically extended virtual disks so that the unutilized storage space in the RAID groups may be allocated for customer usage.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for provisioning and allocating logically extended virtual disks, the method comprising:
responsive to an identification of a negative operational issue with a storage device in a plurality of storage devices in a storage subsystem, determining whether a hot spare disk is available to replace the storage device;
responsive to the hot spare disk being unavailable, allocating a logically extended virtual disk as a replacement for the storage device; and
rebuilding data stored on the storage device on the logically extended virtual disk.

2. The method of claim 1, wherein the logically extended virtual disk is formed utilizing unutilized portions of one or more redundant array of independent disks (RAID) groups.

3. The method of claim 1, further comprising:
determining whether current backup storage capacity meets current requirements;
responsive to an insufficient backup storage capacity, allocating unutilized storage space within each of a plurality of redundant array of independent disks (RAID) groups in the storage subsystem as an independent logical unit number (LUN) within the RAID group;
grouping the allocated independent LUNs within the plurality of RAID groups into a single compounded LUN;
converting, mapping, and masking the single compounded LUN into one or more logically extended virtual disks equal in size to a size of a storage device in the storage subsystem; and
providing a representation of the one or more logically extended virtual disks in a logical container in the storage subsystem.

4. The method of claim 1, further comprising:
determining whether the storage device has been repaired or replaced;
responsive to the storage device being repaired or replaced, determining whether current backup storage capacity meets current requirements; and
responsive to sufficient backup storage capacity, rebuilding the data stored on the logically extended virtual disk on the storage device.

5. The method of claim 4, further comprising:
destroying the logically extended virtual disk; and
returning the unutilized storage space to the plurality of RAID groups.

6. The method of claim 1, further comprising:
responsive to the hot spare disk being available, allocating the hot spare disk as a replacement for the storage device; and
rebuilding data stored on the storage device on the hot spare disk.

7. The method of claim 6, further comprising:
determining whether the storage device has been repaired or replaced;
responsive to the storage device being repaired or replaced, determining whether current backup storage capacity meets current requirements;
responsive to sufficient backup storage capacity, rebuilding the data stored on the hot spare disk on the storage device; and
marking the hot spare disk as available.

8. A computer program product comprising a computer readable storage medium having a computer readable program stored therein, wherein the computer readable program, when executed on a computing device, causes the computing device to:
responsive to an identification of a negative operational issue with a storage device in a plurality of storage devices in a storage subsystem, determine whether a hot spare disk is available to replace the storage device;
responsive to the hot spare disk being unavailable, allocate a logically extended virtual disk as a replacement for the storage device; and
rebuild data stored on the storage device on the logically extended virtual disk.

9. The computer program product of claim 8, wherein the logically extended virtual disk is formed utilizing unutilized portions of one or more redundant array of independent disks (RAID) groups.

10. The computer program product of claim 8, wherein the computer readable program further causes the computing device to:
determine whether current backup storage capacity meets current requirements;
responsive to an insufficient backup storage capacity, allocate unutilized storage space within each of a plurality of redundant array of independent disks (RAID) groups in the storage subsystem as an independent logical unit number (LUN) within the RAID group;
group the allocated independent LUNs within the plurality of RAID groups into a single compounded LUN;
convert, map, and mask the single compounded LUN into one or more logically extended virtual disks equal in size to a size of a storage device in the storage subsystem; and
provide a representation of the one or more logically extended virtual disks in a logical container in the storage subsystem.

11. The computer program product of claim 8, wherein the computer readable program further causes the computing device to:
determine whether the storage device has been repaired or replaced;
responsive to the storage device being repaired or replaced, determine whether current backup storage capacity meets current requirements; and
responsive to sufficient backup storage capacity, rebuild the data stored on the logically extended virtual disk on the storage device.

12. The computer program product of claim 11, wherein the computer readable program further causes the computing device to:
destroy the logically extended virtual disk; and
return the unutilized storage space to the plurality of RAID groups.

13. The computer program product of claim 8, wherein the computer readable program further causes the computing device to:
responsive to the hot spare disk being available, allocate the hot spare disk as a replacement for the storage device; and
rebuild data stored on the storage device on the hot spare disk.

14. The computer program product of claim 13, wherein the computer readable program further causes the computing device to:
determine whether the storage device has been repaired or replaced;
responsive to the storage device being repaired or replaced, determine whether current backup storage capacity meets current requirements;
responsive to sufficient backup storage capacity, rebuild the data stored on the hot spare disk on the storage device; and
mark the hot spare disk as available.

15. An apparatus, comprising:
a processor; and
a memory coupled to the processor, wherein the memory comprises instructions which, when executed by the processor, cause the processor to:
responsive to an identification of a negative operational issue with a storage device in a plurality of storage devices in a storage subsystem, determine whether a hot spare disk is available to replace the storage device;
responsive to the hot spare disk being unavailable, allocate a logically extended virtual disk as a replacement for the storage device; and
rebuild data stored on the storage device on the logically extended virtual disk.

16. The apparatus of claim 15, wherein the logically extended virtual disk is formed utilizing unutilized portions of one or more redundant array of independent disks (RAID) groups.

17. The apparatus of claim 15, wherein the instructions further cause the processor to:
determine whether current backup storage capacity meets current requirements;
responsive to an insufficient backup storage capacity, allocate unutilized storage space within each of a plurality of redundant array of independent disks (RAID) groups in the storage subsystem as an independent logical unit number (LUN) within the RAID group;
group the allocated independent LUNs within the plurality of RAID groups into a single compounded LUN;
convert, map, and mask the single compounded LUN into one or more logically extended virtual disks equal in size to a size of a storage device in the storage subsystem; and
provide a representation of the one or more logically extended virtual disks in a logical container in the storage subsystem.

18. The apparatus of claim 15, wherein the instructions further cause the processor to:
determine whether the storage device has been repaired or replaced;
responsive to the storage device being repaired or replaced, determine whether current backup storage capacity meets current requirements; and
responsive to sufficient backup storage capacity, rebuild the data stored on the logically extended virtual disk on the storage device.

19. The apparatus of claim 18, wherein the instructions further cause the processor to:
destroy the logically extended virtual disk; and
return the unutilized storage space to the plurality of RAID groups.

20. The apparatus of claim 15, wherein the instructions further cause the processor to:
responsive to the hot spare disk being available, allocate the hot spare disk as a replacement for the storage device; and
rebuild data stored on the storage device on the hot spare disk.

21. The apparatus of claim 15, wherein the instructions further cause the processor to:
determine whether the storage device has been repaired or replaced;
responsive to the storage device being repaired or replaced, determine whether current backup storage capacity meets current requirements;
responsive to sufficient backup storage capacity, rebuild the data stored on the hot spare disk on the storage device; and
mark the hot spare disk as available.
